(19) United States
(12) Patent Application Publication
(10) Pub. No.: US 2005/0091154 A1
(43) Pub. Date: Apr. 28, 2005

(54) Method of settlement using mobile communication terminal

(75) Inventors: Shuichiro Yokoyama, Tokyo (JP); Yoshihiro Tsuboi, Tokyo (JP); Kenji Hayashi, Tokyo (JP); Hiroshi Mori, Tokyo (JP)

Correspondence Address: SNIDER & ASSOCIATES, P. O. BOX 27613, WASHINGTON, DC, 20038-7613, US

(73) Assignee: TRI-C INC, Tokyo (JP)

(21) Appl. No.: 10/503,662

(22) PCT Filed: Feb. 7, 2003
(86) PCT No.: PCT/JP03/01311

(30) Foreign Application Priority Data
Feb. 8, 2002 (JP) 2002-32952

(51) Int. Cl. G06F 17/60

(52) U.S. Cl. 705/40

(57) ABSTRACT

There is proposed a settlement method that facilitates use of credit cards, debit cards, and various kinds of electronic money by using a familiar device. A settlement method by various payment means using a subscriber terminal device of a mobile communication system that can be connected to the Internet includes a process for originating a call from the subscriber terminal device, conducting communication with a database, and authenticating a payee; a process for displaying views on a screen of the subscriber terminal device in accordance with contents registered in the database, accepting at least a payment due and a payer name entered on the subscriber terminal device, and ascertaining whether there is illegality in the entered contents; a process responsive to no illegality in the entered contents for accepting a settlement number and a term of validity of the various payment means entered on the subscriber terminal device, acquiring an upper limit of use from the database on the basis of the entered contents, and determining whether the payment due is within the upper limit of use; a process for displaying at least the payer name, the payment due, the settlement number and the term of validity of various payment means on the subscriber terminal device if the payment due is within the upper limit of use, and transmitting settlement information from the subscriber terminal device to a settlement site in accordance with a payment operation corresponding to the display; a process for conducting communication from the settlement site, which has received the settlement information, to an administrative corporation of the various payment means, and requesting authentication; and a process responsive to success of the authentication, for executing settlement fixing processing between the settlement site and the subscriber terminal device and displaying settlement completion on the subscriber terminal device.

### BACKGROUND OF THE INVENTION

The present invention relates to a settling method using a credit card, a debit card, or one of various kinds of electronic money utilized by a mobile communication system represented by portable telephones.

Credit cards and debit cards have now filtered into consumers widely. In convenience stores, payment using a card has become possible. As its settlement method, a method of inserting a credit card into a card reader dedicated to settlement and installed in a store is typical. As for debit cards as well, a method of inserting a card into a card reader dedicated to settlement is adopted in the same way as the settlement of the credit cards. In a store having no card readers, debit cards cannot be used at all under the existing conditions.

Even if a person has a credit card, a debit card, or one of various kinds of electronic money, it cannot be used provided that a terminal for settlement is not installed in the store. For example, a credit card, a debit card, or various kinds of electronic money cannot be used easily as payment means in ordering pizza delivery.

### SUMMARY OF THE INVENTION

In accordance with the present invention, a settlement method by various payment means using a subscriber terminal device of a mobile communication system that can be connected to the Internet, and the settlement method comprising of a process for originating a call from the subscriber terminal device, conducting communication with a database, and authenticating a payee; a process for displaying views on a screen of the subscriber terminal device in accordance with contents registered in the database, accepting at least a payment due and a payer name entered on the subscriber terminal device, and ascertaining whether there is illegality in the entered contents; a process responsive to no illegality in the entered contents for accepting a settlement number and a term of validity of the various payment means entered on the subscriber terminal device, acquiring an upper limit of use from the database on the basis of the entered contents, and determining whether the payment due is within the upper limit of use; a process for displaying at least the payer name, the payment due, the settlement number and the term of validity of various payment means on the subscriber terminal device if the payment due is within the upper limit of use, and transmitting settlement information from the subscriber terminal device to a settlement site in accordance with a payment operation corresponding to the display; a process for conducting communication from the settlement site, which has received the settlement information, to an administrative corporation of the various payment means, and requesting authentication; and a process responsive to success of the authentication, for executing settlement fixing processing between the settlement site and the subscriber terminal device and displaying settlement completion on the subscriber terminal device.

In this settlement method, the side of payee, for example, each of employees of a delivery pizza store or a taxi corporation owns a user ID and a password, then, authenticating the payee by using a subscriber terminal device of a payer or a payee side, which enables settlement by various payment means at a destination of delivery pizza or in an automobile. As the various payment means, debit cards and various kinds of electronic money such as prepaid electronic money can also be used besides credit cards.

There is also proposed a settlement method by various payment means using an adapter connected to an expansion terminal in a subscriber terminal device of a mobile communication system that can be connected to the Internet Includes: a process for originating a call from the subscriber terminal device by connecting the adapter, conducting communication with a database, displaying views on a screen of the subscriber terminal device with adapter in accordance with contents unique to the adapter registered in the database, accepting at least a payment due and a payer name entered on the subscriber terminal device with adapter, and ascertaining whether there is illegality in the entered contents; a process responsive to no illegality in the entered contents for accepting a settlement number and a term of validity of the various payment means entered on the subscriber terminal device with adapter, acquiring an upper limit of use from the database on the basis of the entered contents, and determining whether the payment due is within the upper limit of use; a process for displaying at least the payer name, the payment due, the settlement number and the term of validity of the various payment means on the subscriber terminal device with adapter if the payment due is within the upper limit of use, and transmitting settlement information from the subscriber terminal device with adapter to a settlement site in accordance with a payment operation corresponding to the display; a process for conducting communication from the settlement site, which has received the settlement information, to an administrative corporation of the various payment means, and requesting authentication; and a process responsive to success of the authentication, for executing settlement fixing processing between the settlement site and the subscriber terminal device with adapter and displaying settlement completion on the subscriber terminal device with adapter.

The adapter in this method incorporates a microcomputer, and it can be made small in size. Therefore, the payee side, for example, each of employees of a delivery pizza store or a taxi corporation can put the adapter in a pocket and carry it easily. By using a subscriber terminal device of a payer or a payee side, settlement using various payment means can be completed at a destination place of pizza delivery or in an automobile, so long as there is an adapter.

In such a settlement method using the various payment means, contact information of the payer is also entered for ascertainment when entering a payment due and a payer name on the subscriber terminal device with adapter. It is preferred to have formalities to determine whether there is illegality (such as use of a symbol that cannot be entered, or too many number of digit) in it's entering as well. As such contact information, E-mail address or a telephone number (fixed telephone or portable telephone) can be used. If the contact information is ascertained, an administrative corporation of the various payment means can make contact for personal verification at later time. In addition, if the contact information is a telephone number, then it is also possible to ascertain whether the provided phone number actually exists by inquiring a database when ascertaining illegality.

In the process for determining whether the payment due is within the upper limit of use in the settlement method of the present invention, it is possible to acquire an upper limit of payee provided for the payee (in the case of chained stores, it is desirable to provide an upper limit for each store), an upper limit of number provided for the settlement number of the various payment means, and an upper limit of employee provided for each of employees belonging to the store or an upper limit of adapter provided for an adapter are acquired from the database, and determine whether the payment due does not exceed the acquired upper limits. Each of these upper limits may be an upper limit per use of each time. More preferably, however, amounts of settlement money that have succeeded in totalizing periods determined respectively for the upper limits are inquired of the database and totalized respectively for the upper limits, and it is determined whether sum totals of these totalized amounts of money of settlements and the payment due do not exceed the corresponding upper limits. The totalizing period of the upper limits can be determined to be one month for the upper limit of the payee and the upper limit of the number, and to be one day for the upper limit of the employee or the upper limit of the adapter. In this case, the amount of settlements that have succeeded are totalized between the first day of that month and that day for the upper limit of the payee and the upper limit of the number, and the amount of settlements that have succeeded are totalized until the current point in time on that day for the upper limit of the employee or the upper limit of the adapter. If the totalizing periods are thus determined, it is effective in preventing a crime such as a fraud. In other words, if an upper limit is set for each time, settlement can be executed again and again so long as the upper limit is met each time. In order to prevent this, therefore, it is desirable to determine the upper limit per month or per day.

### BRIEF DESCRIPTION OF THE DRAWINGS

FIG. 1 is a flow chart showing a processing process executed in a subscriber terminal device according to the present invention;

FIG. 2 is a flow chart following the flow chart shown in FIG. 1;

FIG. 3 is a diagram showing a view displayed on a subscriber terminal device when entering a payment due and a credit card owner name;

FIG. 4 is a diagram showing a view displayed on a subscriber terminal device when entering a credit card number and a term of validity;

FIG. 5 is a diagram showing a view displayed on a subscriber terminal device when ascertaining a payment due and so on and executing a payment operation, and an error view displayed on a settlement site when an upper limit of use in the amount of money is exceeded;

FIG. 6 is a diagram showing an error view displayed on a settlement site when authentication could not be conducted by a card corporation;

FIG. 7 is a diagram showing a view displayed on a subscriber terminal device when settlement has been completed;

FIG. 8 is a diagram showing mail transmitted to a payee after settlement has been completed;

FIG. 9 is a flow chart showing a processing process executed in a subscriber terminal device with an adapter inserted therein according to a second embodiment of the present invention; and

FIG. 10 is a flow chart following a flow chart shown in FIG. 9.

### DESCRIPTION OF THE PREFERRED EMBODIMENTS

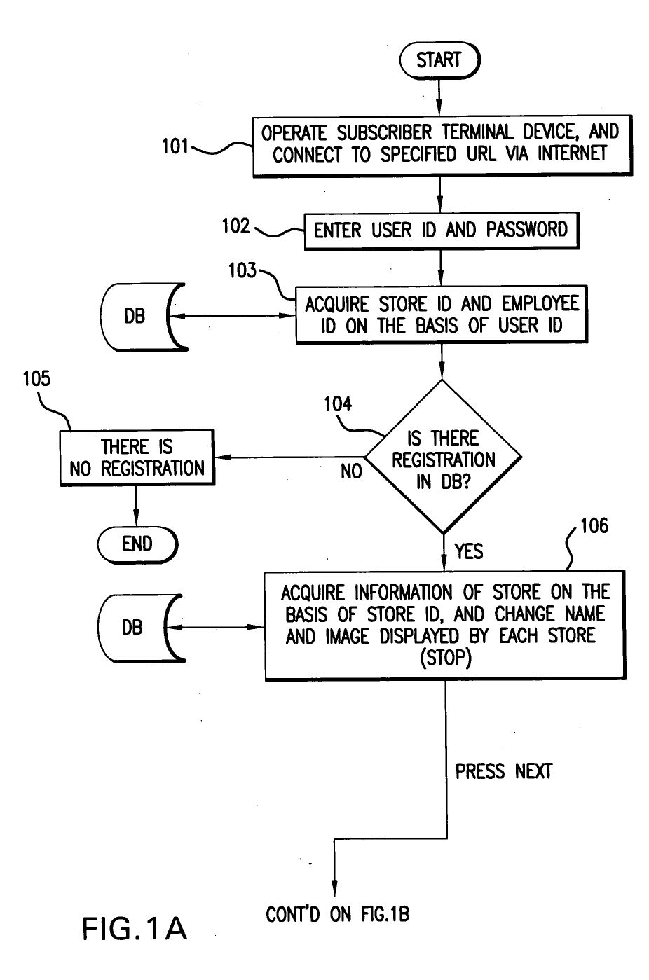

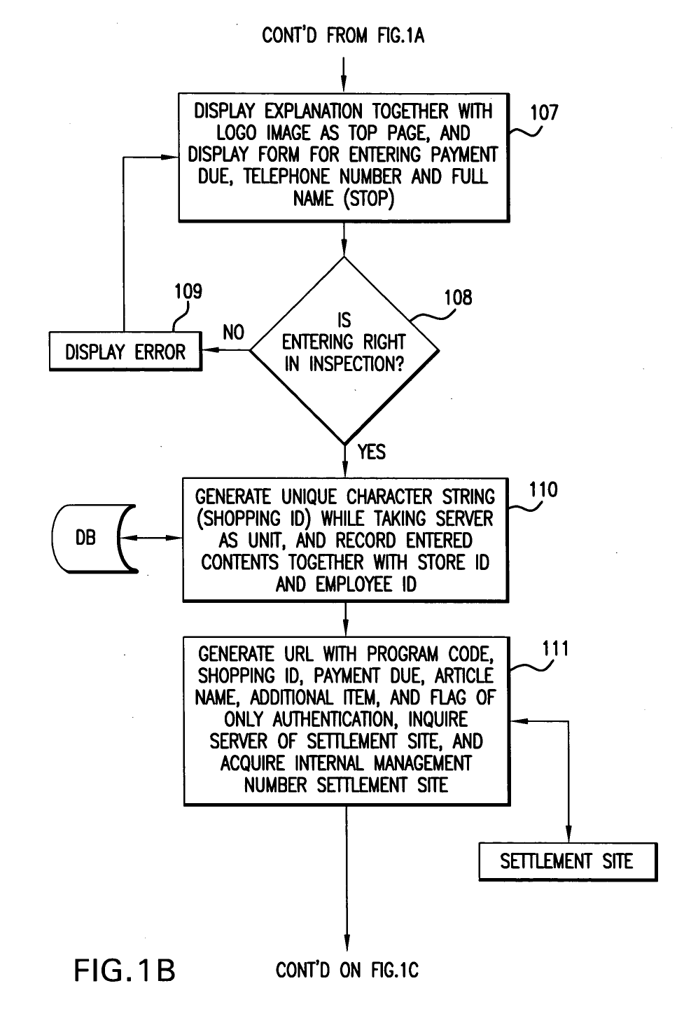

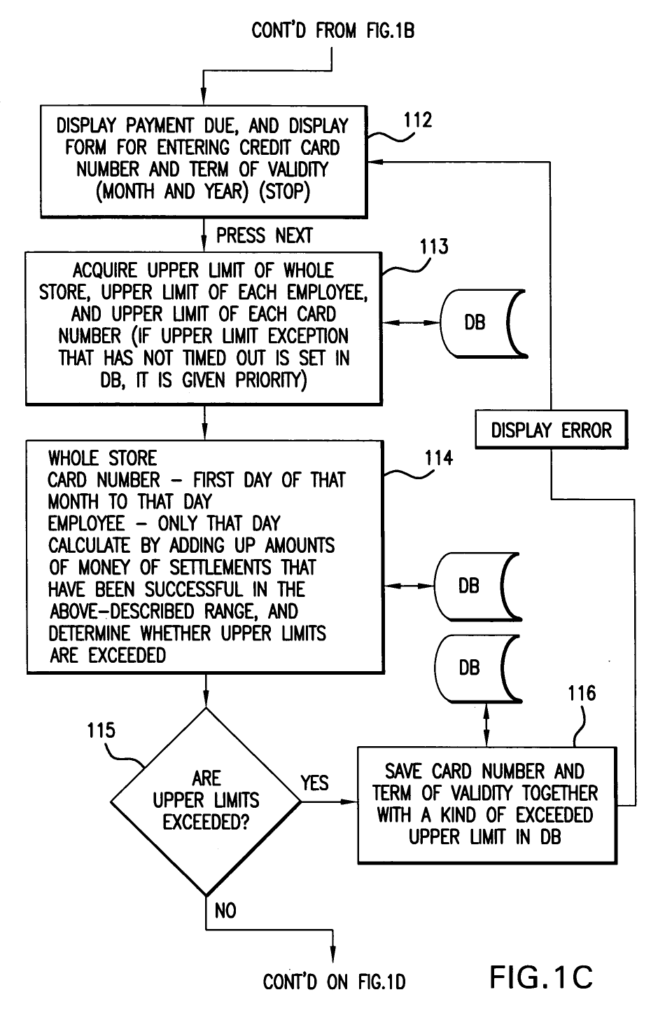

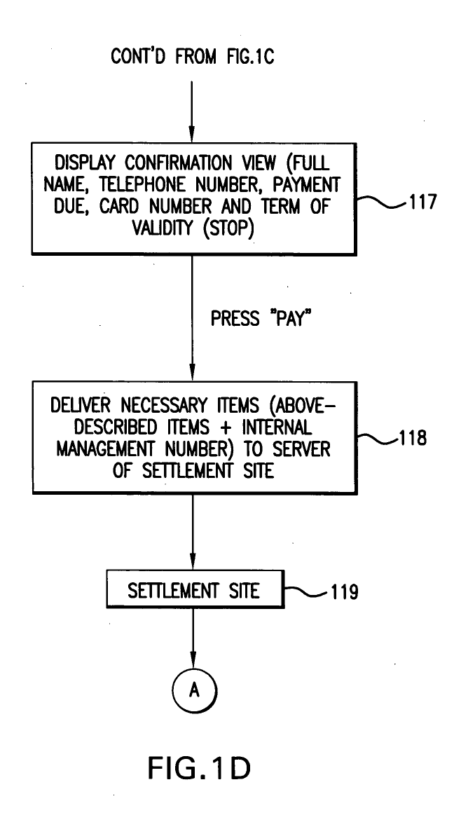

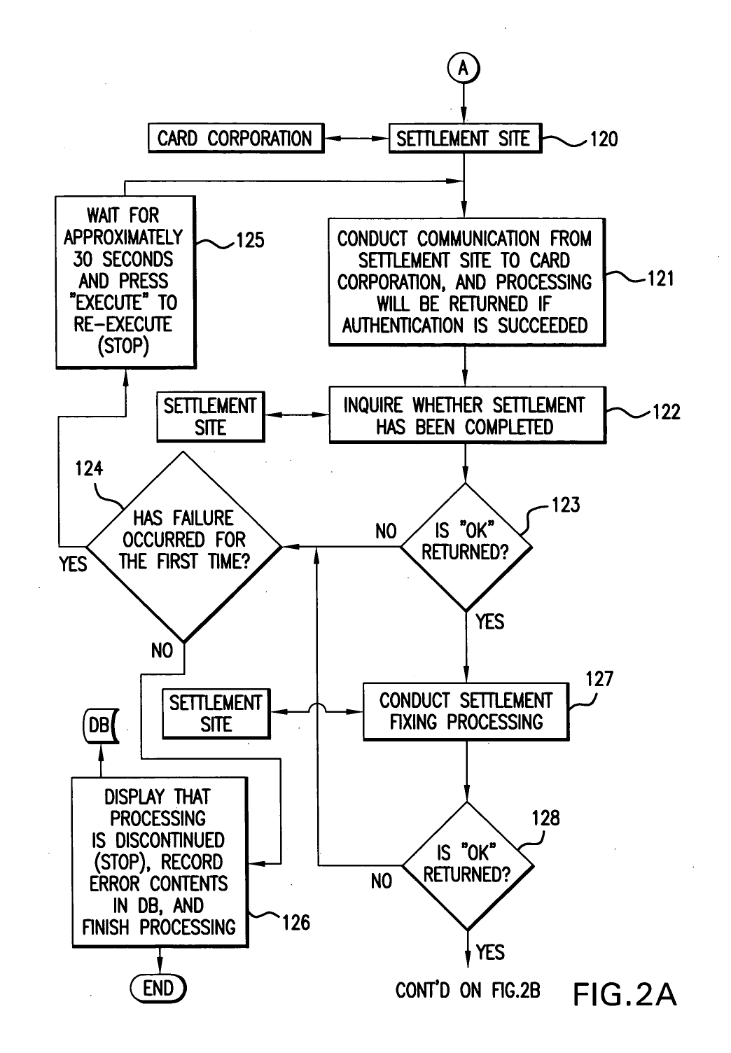

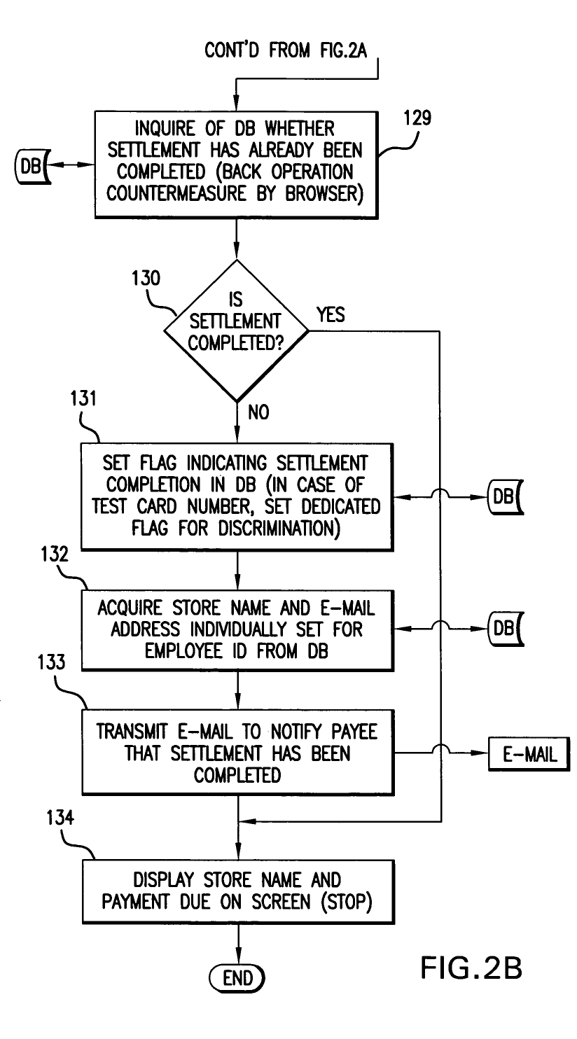

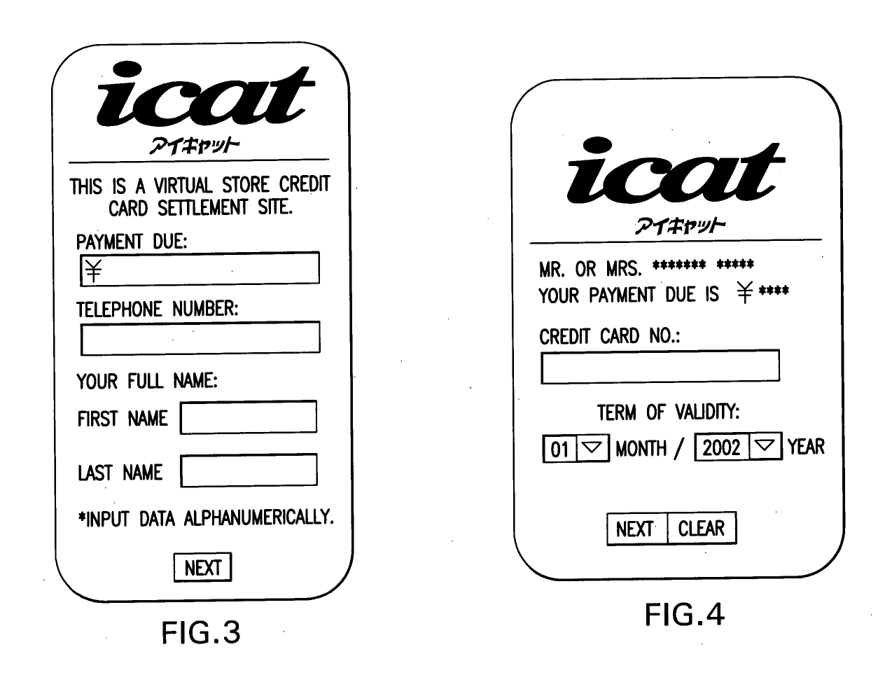

While exemplifying views displayed on a subscriber terminal device, concrete examples of processing processes in the case where a credit card is used. FIGS. 1 and 2 show flow charts of processing seen from the subscriber terminal device side. FIGS. 3 to 7 show views displayed on the terminal device in the processes.

(First Embodiment)

Hereafter, concrete examples of the processing processes will be described. First, a subscriber terminal device is connected to a specific URL (Uniform Resource Locator) via the Internet (step 101). Subsequently, a user ID and a password are entered (step 102). Authentication work is conducted on the entered user ID and password in a database (DB). If the user ID is already registered, then a store ID and an employee ID which associates with the user ID are acquired (steps 103 and 104). In the user ID, a store ID for managing store information and an employee ID for managing information of an employee belonging to the store are associated and registered in a database. As for the password, a one-time password may be used instead of registering a fixed password beforehand. In this case, the password is made disposable each time. Even if a password is stolen, therefore, the same password cannot be used twice, resulting in enhanced security.

If it is found as a result of the authentication work that there is no registration of the user ID in the DB, then the processing is finished at that time (step 105). If there is registration in the DB, then a store name and an image unique to a payee are prepared in accordance with the store ID acquired from the DB (step 106). Subsequently, explanation of processing contents to be conducted thereafter is displayed together with a logo as a top page. And an entering form view of a payment due and contact information of a payer (credit card owner), such as a telephone number and a credit card owner name (full name) in the present example, is displayed (step 107). An example of a view displayed on the subscriber terminal device at the step 107 is shown in FIG. 3.

In accordance with the displayed view, the payee first enters a payment due, hands the subscribed terminal device to the payer, and makes the payer enter the telephone number of communication destination and the credit card owner name by himself or herself. If a return button (displayed as “Next” in FIGS. 3 and 4) in the view is clicked, then it is determined whether there is illegality, such as whether characters have been entered by using half size alphanumeric characters, whether a character that cannot be used has been used, or whether a telephone number is unnatural (step 108). If as a result there is illegality in the entered contents, then an error is displayed (step 109), and the processing returns to the step 107 to retry. The error display at this time is for example, “There is illegality in entering your name. Please enter your name again,” “The telephone number is not right. Please enter your telephone number again,” and “The payment due is not right. Please enter the payment due again.”

On the other hand, if there are no mistakes in the entered contents, then a unique character string is generated as a shopping ID by a server unit in the settlement site (i.e., encryption is conducted), and the entered contents are recorded in the DB together with the store ID and the employee ID (step 110). Subsequently, a URL provided with a program code, a shopping ID, a payment due, an article name, an additional item, and a flag of only authentication is generated, and a query is sent to the server of the settlement site to acquire an internal management number (step 111). The “program code” is an agent ID assigned to an agent of pertinent settlement software by the settlement site. The “article name” is an arbitrary character string (such as the agent name) defined in communication specifications for the settlement site. The “additional item” is a character string for internal processing delivered in order to facilitate finding a problem when the problem has occurred.

Upon acquisition of the internal management number, an entering form view of a credit card number and a term of validity is displayed together with the payment due entered earlier (step 112). FIG. 4 shows the entering form displayed at the step 112. In this example, the full name of the payer and the payment due are displayed in an upper part. An entering column of a credit card number and an entering column of a term of validity are displayed under the upper part. In case of the present example, the term of validity is entered by a selection form.

If the entering operation is completed and a return button (a button having indication “next”) is clicked, then an upper use limit in the store=an upper limit of the payee, an upper limit of each employee belonging to the store=an upper limit of the employee, and an upper use limit of the card number=an upper limit of the number are acquired from the DB (step 113). In case of the present example, the sum total of use per month is determined as an upper limit for the upper limit of the payee and the upper limit of the number, whereas the total sum of use per day is determined as an upper limit for the upper limit of the employee. If at this time an upper limit exception that has not been timed out is set in the DB, then it is given priority. For example, if there is a special increase in the upper limit of the payee or the upper limit of the employee because of campaign (upper limit exception), then the upper limit exception is given priority during the campaign period (unless timeout has occurred).

Respective upper limits are thus acquired. As for the upper limit of the payee for the store and the upper limit of the number for the credit card number, amounts of money of settlements that have succeeded (that have been set in a settlement completion flag) since the first day of the month until that day are inquired of the DB and totalized. As for the upper limit of the employee for an employee belonging to the store, amounts of money of settlements that have succeeded until the current point in time of that day are inquired of the DB and totalized. The payment due is added to respective total amounts of settlements to calculate respective total amounts (step 114).

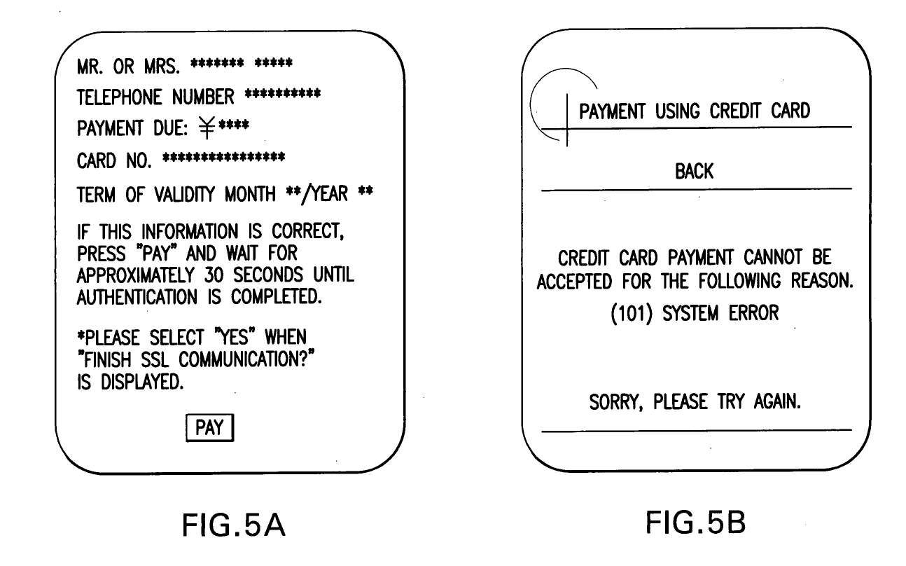

Subsequently, comparison is executed for each of upper limits to determine whether the respective calculated total amounts exceed the upper limit of the payee, the upper limit of the number, and the upper limit of the employee (step 115). If any of the upper limits is exceeded, then the kind of the exceeded upper limit, i.e., the upper limit of the payee, the upper limit of the number, or the upper limit of the employee is saved in the DB together with the credit card number and the term of validity, an error is displayed in the settlement site, and the processing returns to the step 112 (step 116). On the other hand, if any upper limit is not exceeded, then an ascertainment view of the full name, the telephone number, the payment due, the credit card number and the term of validity is displayed (step 117). FIG. 5(A) shows an ascertainment view displayed on the subscriber terminal device at the step 117. If an error is found at the step 116, then an error display view shown in FIG. 5(B) is displayed on the settlement site side.

If the ascertainment view is displayed at the step 117 and a return button (displayed as “pay” button) in the view is clicked as a payment operation, then transmission to the settlement site is conducted, and items of the above-described credit card owner name, telephone number, payment due, credit card number, and the term of validity, and the internal management number acquired at the step 111 are delivered (step 118).

It is desirable that communication at this time is conducted in the SSL (Secure Sockets Layer).

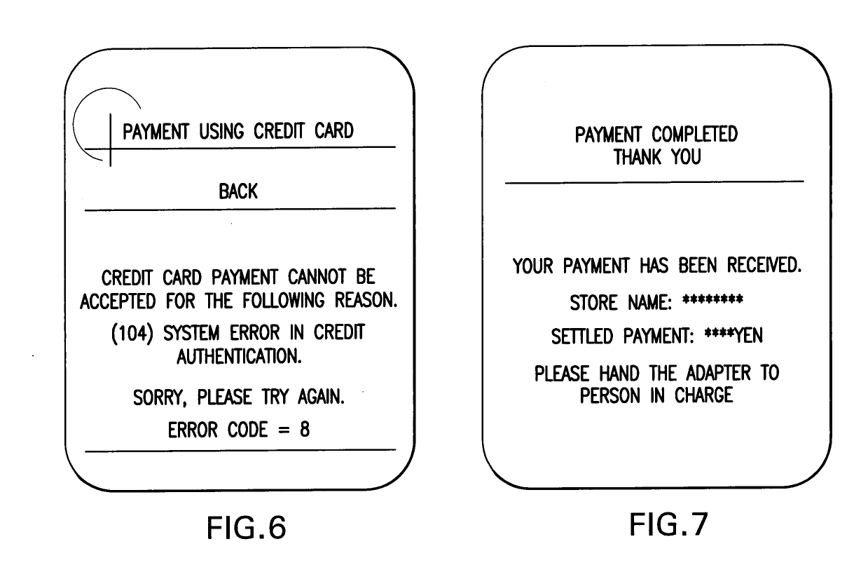

If settlement information containing these necessary items is delivered to the settlement site (step 119), then authentication is conducted from the settlement site to a card corporation (step 120). If the authentication has succeeded, the processing returns from the settlement site (step 121). If at this time the card number is imaginary, the card is rejected. In this case, an error view shown in FIG. 6 is displayed.

The settlement processing of the steps 116 to 121 is conducted by temporarily delivering the processing to the settlement site. For example, however, the settlement processing itself may also be conducted in the present system instead of separating the present system from the settlement site.

The subscriber terminal, which has delivered the settlement information at the step 118, inquires of the settlement site whether the settlement may be conducted after a predetermined time (for example, 30 seconds) (step 122), and determines whether “OK” is returned (step 123). If “OK” is not returned, then it is determined whether the failure has occurred for the first time (step 124), If the failure has occurred for the first time, then the user is requested to wait for a predetermined time (for example, approximately 30 seconds) and execute the payment operation once more (step 125). If it is found at the step 124 that the failure has not occurred for the first time, then authentication cannot be conducted, and consequently an error display to the effect that the processing is discontinued is conducted, and contents of the error are recorded in the DB, and the processing is finished (step 126). It is also possible to prevent the same credit card number from being accepted thereafter, by recording the error contents in the DB.

If “OK” is returned at the step 123, then settlement fixing processing is conducted between the present system and the settlement site (step 127). It is monitored whether “OK” is returned (step 128). If “OK” is not returned, then the process of the step 124 and subsequent steps is executed. If “OK” is returned, then the present system inquires of DB whether settlement is already completed (step 129). This is a countermeasure against a back operation (operation of “back” button) of the browser conducted in the subscriber terminal device. If the settlement is not completed (a completion flag is not set) (step 130), then a flag indicating the settlement completion is set in the DB and a mark of settlement completion is put (step 131). This flag serves as an index when totalizing the amounts of money of the successful settlements every card number.

Subsequently, the store name and E-mail address are acquired (step 132). E-mail to the effect that the settlement has been completed is delivered to the E-mail address, i.e., to the payee (step 133). And a payment completion view representing the store name and the payment due is displayed on the terminal screen and the processing is finished (step 134). If it is ascertained at the step 130 that the settlement has already been completed (the completion flag has been set), then the processing jumps to the step 134 to display the payment completion view representing the store name and the payment due and the processing is finished.

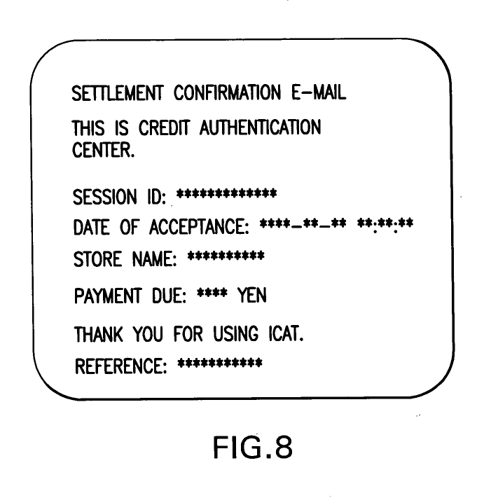

FIG. 7 shows the view displayed at the step 134. FIG. 8 shows contents of the E-mail transmitted to the payee at the step 133.

(Second Embodiment)

As another embodiment, a settlement method using a credit card and an adapter will now be described. First, the adapter is inserted into an expansion terminal in a subscriber terminal device, such as a portable telephone, in a mobile communication system. Thereupon, a microcomputer incorporated in the adapter is started. A call is automatically originated from the subscriber terminal device via the Internet, and the microcomputer is connected to a URL specified beforehand (step 201). Subsequently, an SSID (Service Set Identification) unique to the adapter is acquired by discomposing the URL (step 202). Inquiries are made in order to acquire a payee ID provided for a payee who is an owner of the adapter, and an adapter ID provided for the adapter itself from a database (DB) of the URL currently connected (step 203). In the case where the payee has a plurality of stores, it is desirable to register the payee ID as a store ID by every store. In the present example, a store ID and an adapter ID assigned to each adapter while taking the store as the unit are set.

Subsequently, it is determined whether there is registration of the SSID in the DB (step 204). If there is no registration, then the processing is finished at that point in time (step 205). If there is registration in the DB, then a store name and an image unique to a payee are prepared in accordance with the store ID acquired from the DB (step 206). Subsequently, explanation of processing contents to be conducted thereafter is displayed together with a logo as a top page. And an entering form view of a payment due and contact information of a payer (credit card owner), such as a telephone number and a credit card owner name (full name) in the present example, is displayed (step 207). An example of a view displayed on the subscriber terminal device with adapter at the step 207 is shown in FIG. 3.

In accordance with the displayed view, the payee side first enters a payment due, hands the subscribed terminal device with adapter to the payer, and makes the payer enter the telephone number of communication destination and the credit card owner name by himself or herself. If a return button (displayed as “Next” in FIGS. 3 and 4) in the view is clicked, then it is determined whether there is illegality, such as whether characters have been entered by using half size alphanumeric characters, whether a character that cannot be used has been used, or whether a telephone number is unnatural (step 208). If as a result there is illegality in the entered contents, then an error is displayed (step 209), and the processing returns to the step 207 to retry. The error display at this time is for example, “There is illegality in entering your name. Please enter your name again.” “The telephone number is not right. Please enter your telephone number again.” “The payment due is not right. Please enter the payment due again.”

On the other hand, if there are no mistakes in the entered contents, then a unique character string is generated as a shopping ID by taking a server in the settlement site as the unit (i.e., encryption is conducted), and the entered contents are recorded in the DB together with the store ID and the employee ID (step 210). Subsequently, a URL provided with a program code, a shopping ID, a payment due, an article name, an additional item, and a flag of only authentication is generated, and a query is sent to the server of the settlement site to acquire an internal management number (step 211). The “program code” is an agent ID assigned to an agent of pertinent settlement software by the settlement site. The “article name” is an arbitrary character string (such as the agent name) defined in communication specifications for the settlement site. The “additional item” is a character string for internal processing delivered in order to facilitate finding a problem when the problem has occurred.

Upon acquisition of the internal management number, an entering form view of a credit card number and a term of validity is together with the payment due entered earlier (step 212). FIG. 4 shows the entering form displayed at the step 212. In this example, the full name of the payer and the payment due are displayed in an upper part. An entering column of a credit card number and an entering column of a term of validity are displayed under the upper part. In the case of the present example, the term of validity is entered by a selection form.

If the entering operation is completed and a return button (a button having indication “next”) is clicked, then an upper use limit in the store=an upper limit of the payee, an upper limit of each adapter=an upper limit of the adapter, and an upper use limit of the card number=an upper limit of the number are acquired from the DB (step 213). In the case of the present example, the sum total of use per month is determined as an upper limit for the upper limit of the payee and the upper limit of the number, whereas the total sum of use per day is determined as an upper limit for the upper limit of the adapter. If at this time an upper limit exception that has not been timed out is set in the DB, then it is given priority. For example, if there is a special increase in the upper limit of the payee or the upper limit of the adapter because of campaign (upper limit exception), then the upper limit exception is given priority during the campaign period (unless timeout has occurred).

Respective upper limits are thus acquired. As for the upper limit of the payee for the store and the upper limit of the number for the credit card number, amounts of money of settlements that have succeeded (that have been set in a settlement completion flag) since the first day of the month until that day are inquired of the DB and totalized. As for the upper limit of the adapter for an adapter belonging to the store, amounts of money of settlements that have succeeded until the current point in time of that day are inquired of the DB and totalized. The payment due is added to respective total amounts of settlements to calculate respective total amounts (step 214).

Subsequently, comparison is executed for each of upper limits to determine whether the respective calculated total amounts exceed the upper limit of the payee, the upper limit of the number, and the upper limit of the adapter (step 215). If any of the upper limits is exceeded, then the kind of the exceeded upper limit, i.e., the upper limit of the payee, the upper limit of the number, or the upper limit of the adapter is saved in the DB together with the credit card number and the term of validity, an error is displayed in the settlement site, and the processing returns to the step 212 (step 216). On the other hand, if any upper limit is not exceeded, then an ascertainment view of the full name, the telephone number, the payment due, the credit card number and the term of validity is displayed (step 217). FIG. 5(A) shows an ascertainment view displayed on the subscriber terminal device with adapter at the step 217. If an error is found at the step 216, then an error display view shown in FIG. 5(B) is displayed on the settlement site side.

If the ascertainment view is displayed at the step 217 and a return button (displayed as “pay” button) in the view is clicked as a payment operation, then transmission to the settlement site is conducted, and items of the above-described credit card owner name, telephone number, payment due, credit card number, and the term of validity, and the internal management number acquired at the step 211 are delivered (step 218). It is desirable that communication at this time is conducted in the SSL (Secure Sockets Layer).

If settlement information containing these necessary items is delivered to the settlement site (step 219), then authentication is conducted from the settlement site to a card corporation (step 220). If the authentication has succeeded, the processing returns from the settlement site (step 221). If at this time the card number is imaginary, the card is rejected. In this case, an error view shown in FIG. 6 is displayed at the settlement site.

The subscriber terminal device with adapter, which has delivered the settlement information at the step 218, inquires of the settlement site whether the settlement may be conducted after a predetermined time (for example, 30 seconds) (step 222), and determines whether “OK” is returned (step 223). If “OK” is not returned, then it is determined whether the failure has occurred for the first time (step 224). If the failure has occurred for the first time, then the user is requested to wait for a predetermined time (for example, approximately 30 seconds) and execute the payment operation once more (step 225). If it is found at the step 224 that the failure has not occurred for the first time, then authentication cannot be conducted, and consequently an error display to the effect that the processing is discontinued is conducted, and contents of the error are recorded in the DB, and the processing is finished (step 226) It is also possible to prevent the same credit card number from being accepted thereafter, by recording the error contents in the DB.

If “OK” is returned at the step 223, then settlement fixing processing is conducted between the present system and the settlement site (step 227). It is monitored whether “OK” is returned (step 228). If “OK” is not returned, then the process of the step 224 and subsequent steps is executed. If “OK” is returned, then the present system inquires of DB whether settlement is already completed (step 229). This is a countermeasure against a back operation (operation of “back” button) of the browser conducted in the subscriber terminal device having an adapter. If the settlement is not completed (a completion flag is not set) (step 230), then a flag indicating the settlement completion is set in the DB and a mark of settlement completion is put (step 231). This flag serves as an index when totalizing the amounts of money of the successful settlements every card number.

Subsequently, the store name and E-mail address set so as to be unique to the adapter are acquired (step 232). E-mail to the effect that the settlement has been completed is delivered to the E-mail address, i.e., to the payee (step 233). And a payment completion view representing the store name and the payment due is displayed on the terminal screen and the processing is finished (step 234). If it is ascertained at the step 230 that the settlement has already been completed (the completion flag has been set), then the processing jumps to the step 234 to display the payment completion view representing the store name and the payment due and the processing is finished.

FIG. 7 shows the view displayed at the step 234. FIG. 8 shows contents of the E-mail transmitted to the payee at the step 233.

In the settlement method as above described, it is also possible to previously collect security money from the payee in order to prevent a fraud. As for remittance from the settlement site administrative corporation to the payee, it is desirable to make a contract so as to conduct the remittance after actual receipt of money from the payer, i.e., the credit card owner. Furthermore, by using the adapter, the labor for entering the user ID and password on the subscriber terminal device can be saved. In addition, if the adapter is provided with a function of a card reader, it is also possible to add information read from the credit card besides the information of the credit card owner obtained by using the subscriber terminal device.

In the foregoing description of both the first and second embodiments, a credit card is used. Settlement using a debit card or one of various kinds of electronic money, which is a different settlement means, will now be described. For example, if prepaid electronic money is used as electronic money, then the payer enters a settlement number stated on the prepaid card owned by the payer, in the processing process for entering a credit card number included in the processing in the first or second embodiment. At this time, the full name and telephone number of the payer are entered in the same way as the first and second embodiments. Typically, in the case where such a prepaid card is used, it is seldom that the payer's own information is disclosed. Therefore, it is also possible to omit the payer's own information and enter only a number dedicated to settlement. After entering, processing processes similar to those conducted when using a credit card in the first or second embodiment are executed. Settlement processing of the payee and settlement processing of the prepaid card are conducted (not illustrated), and the payment is completed.

Also when using a debit card, a number of a cash card of a financial agency owned by the payer is entered in the scene in which the credit card number is entered in the first or second embodiment, in the same way as the case where the prepaid card is used. When using a credit card, however, the name and telephone number are entered as information of the payer. However, it is also possible to enter a secret identification number in accordance with the use form of the typical debit card. After the entering, settlement processing of the payee and settlement processing of the debit card are conducted (not illustrated) in the same way as the first or second embodiment, and the payment is completed.

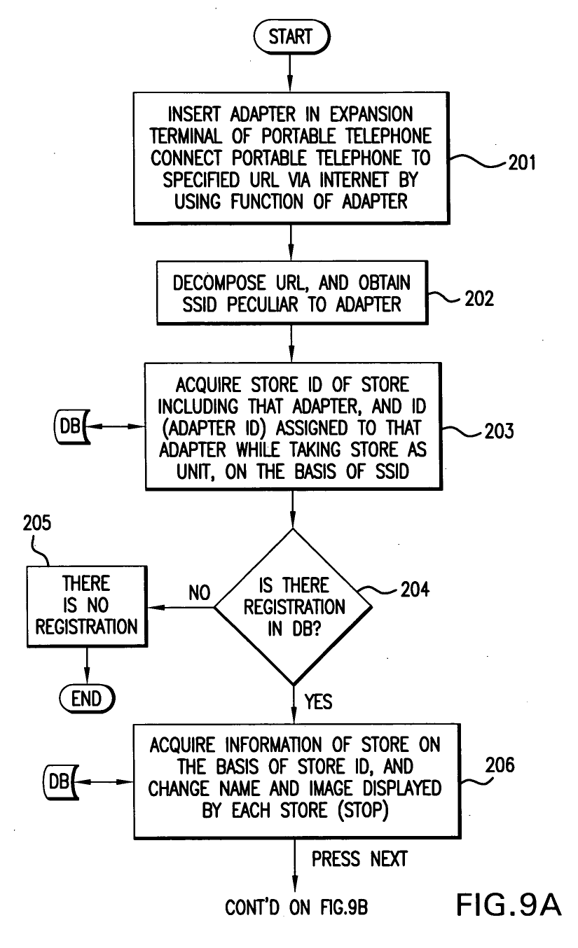

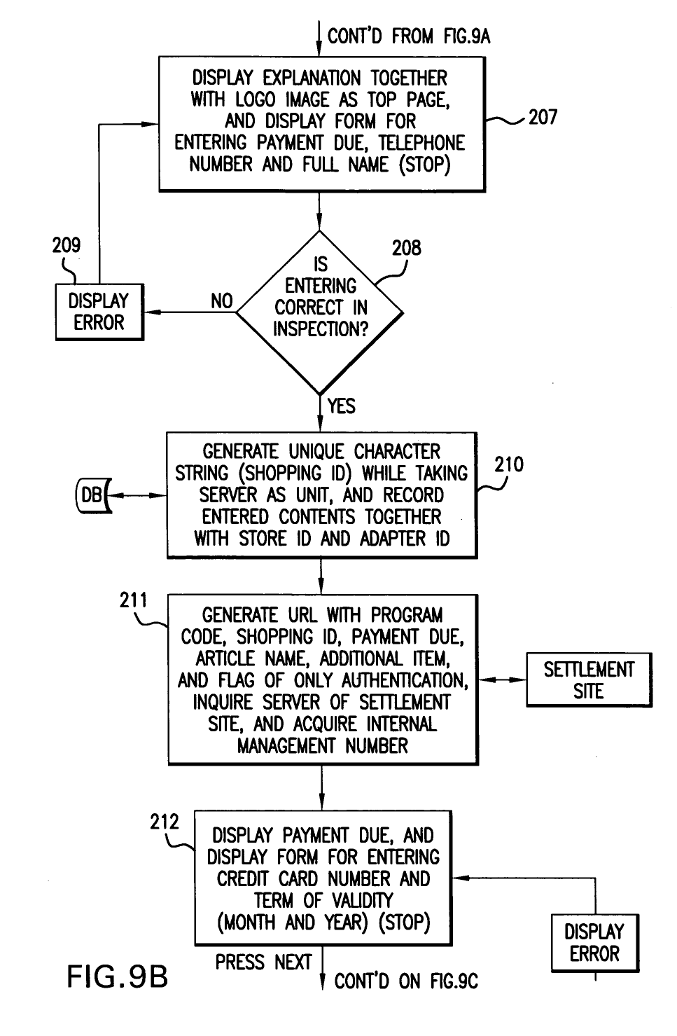

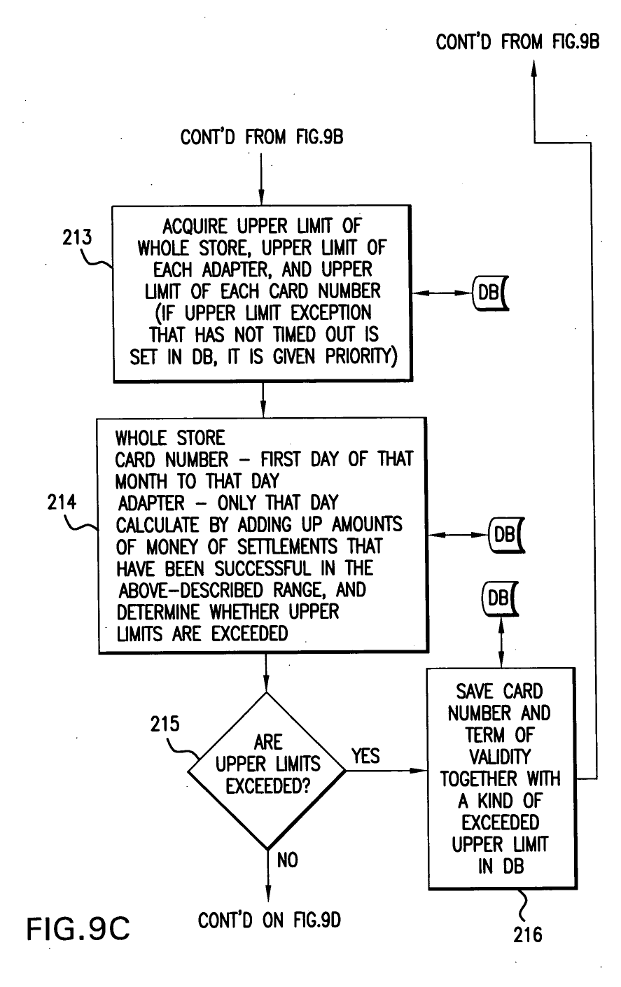

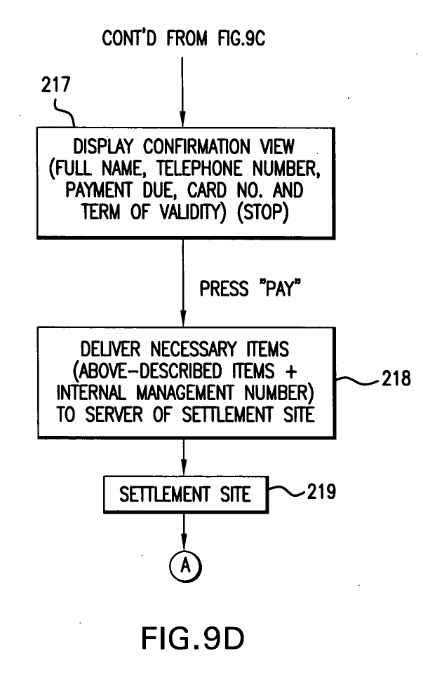

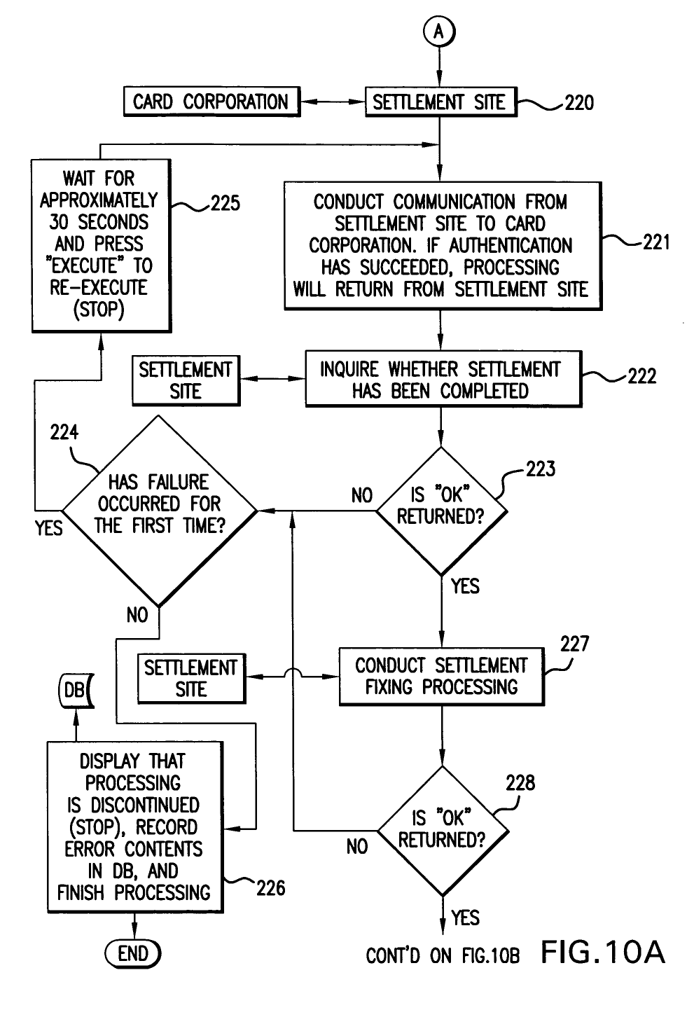

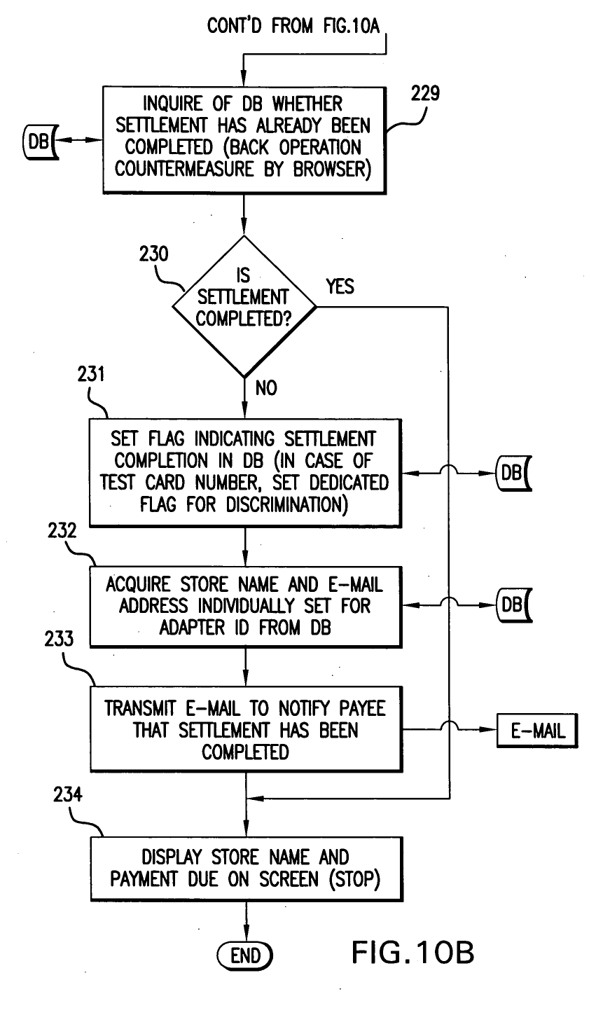

In order to meet the convenience of the payer, the payer may be made to select a credit card, a debit card, or one of various kinds of electronic money as a payment method in, for example, the view displayed at the step 107 in FIG. 1 or at the step 207 in FIG. 9 (the view shown in FIG. 4).

According to the settlement method of the present invention, it becomes possible to conduct settlement using a credit card, a debit card, or one of various kinds of electronic money by using only a subscriber terminal device of mobile communication, such as a portable telephone, as above described. Therefore, the opportunity of using cards can be greatly widened.

1. A settlement method by various payment means using a subscriber terminal device of a mobile communication system that can be connected to the Internet, said settlement method comprising:
a process for originating a call from the subscriber terminal device, conducting communication with a database, and authenticating a payee;
a process for displaying views on a screen of the subscriber terminal device in accordance with contents registered in the database, accepting at least a payment due and a payer name entered on the subscriber terminal device, and ascertaining whether there is illegality in the entered contents;
a process responsive to no illegality in the entered contents for accepting a settlement number and a term of validity of the various payment means entered on the subscriber terminal device, acquiring an upper limit of use from the database on the basis of the entered contents, and determining whether the payment due is within the upper limit of use;
a process for displaying at least the payer name, the payment due, the settlement number and the term of validity of various payment means on the subscriber terminal device if the payment due is within the upper limit of use, and transmitting settlement information from the subscriber terminal device to a settlement site in accordance with a payment operation corresponding to the display;
a process for conducting communication from the settlement site, which has received the settlement information, to an administrative corporation of the various payment means, and requesting authentication; and
a process responsive to success of the authentication, for executing settlement fixing processing between the settlement site and the subscriber terminal device and displaying settlement completion on the subscriber terminal device.

2. The settlement method according to claim 1, wherein authentication of the payee is conducted by using a user ID and a password.

3. The settlement method according to claim 2, wherein information unique to a store of the payee and information of an employee belonging to the store are associated with the user ID and registered in the database.

4. The settlement method according to claim 1, wherein the various payment means are credit cards, debit cards, and various kinds of electronic money.

5. The settlement method according to claim 1, where in a settlement number of the various payment means is a credit card number, a debit card number, or an electronic money number.

6. The settlement method according to claim 1, wherein when entering a payment due and a payer name on the subscriber terminal device, contact information of a payer is also entered.

7. The settlement method according to claim 1, wherein in said process for determining whether the payment due is within the upper limit of use, an upper limit of payee provided for the payee, an upper limit of settlement provided for the various payment means, and an upper limit of employee provided for an employee are acquired from the database, and it is determined whether the payment due does not exceed the acquired upper limits.

8. The settlement method according to claim 7, wherein amounts of money of settlement that have succeeded in totalizing periods determined respectively for the upper limits are inquired of the database and totalized respectively for the upper limits, and it is determined whether sum totals of these totalized amounts of money of settlements and the payment due do not exceed the corresponding upper limits.

9. A settlement method by various payment means using an adapter connected to an expansion terminal in a subscriber terminal device of a mobile communication system that can be connected to the Internet, said settlement method comprising:
a process for originating a call from the subscriber terminal device by connecting the adapter, conducting communication with a database, displaying views on a screen of the subscriber terminal device with adapter in accordance with contents unique to the adapter registered in the database, accepting at least a payment due and a payer name entered on the subscriber terminal device with adapter, and ascertaining whether there is illegality in the entered contents;
a process responsive to no illegality in the entered contents for accepting a settlement number and a term of validity of the various payment means entered on the subscriber terminal device with adapter, acquiring an upper limit of use from the database on the basis of the entered contents, and determining whether the payment due is within the upper limit of use;
a process for displaying at least the payer name, the payment due, the settlement number and the term of validity of the various payment means on the subscriber terminal device if the payment due is within the upper limit of use, and transmitting settlement information from the subscriber terminal device with adapter to a settlement site in accordance with a payment operation corresponding to the display;
a process for conducting communication from the settlement site, which has received the settlement information, to an administrative corporation of the various payment means, and requesting authentication; and
a process responsive to success of the authentication, for executing settlement fixing processing between the settlement site and the subscriber terminal device with adapter and displaying settlement completion on the subscriber terminal device with adapter.

10. The settlement method according to claim 9, wherein the various payment means are credit cards, debit cards, and various kinds of electronic money.

11. The settlement method according to claim 9, wherein a settlement number of the various payment means is a credit card number, a debit card number, or an electronic money number.

12. The settlement method according to claim 9, wherein when entering a payment due and a payer name on the subscriber terminal device with adapter, contact information of a payer is also entered.

13. The settlement method according to claim 12, wherein the contact information is a telephone number.

14. The settlement method according to claim 13, wherein in determining illegal entering, the database is inquired of to determine whether the telephone number is an actually existing telephone number.

15. The settlement method according to claim 9, wherein in said process for determining whether the payment due is within the upper limit of use, an upper limit of payee provided for the payee, an upper limit of number provided for the settlement number of the various payment means, and an upper limit of adapter provided for an adapter are acquired from the database, and it is determined whether the payment due does not exceed the acquired upper limits.

16. The settlement method according to claim 15, wherein amounts of money of settlement that have succeeded in totalizing periods determined respectively for the upper limits are inquired of the database and totalized respectively for the upper limits, and it is determined whether sum totals of these totalized amounts of money of settlements and the payment due do not exceed the corresponding upper limits.
